(19) United States
(12) Patent Application Publication
(10) Pub. No.: US 2026/0198428 A1
(43) Pub. Date: Jul. 16, 2026

(54) ROOF TRAY

(71) Applicant: SIKA TECHNOLOGY AG, BAAR (CH)

(72) Inventors: Alan Sian Ghee LEE, Singapore (SG); Henry GREAVES, Watsons Bay (AU); Raymond Kok Hua LIM, Singapore (SG); Jonathan Xi YUEN, Singapore (SG)

(73) Assignee: SIKA TECHNOLOGY AG, BAAR (CH)

(21) Appl. No.: 19/129,592

(22) PCT Filed: Nov. 14, 2023
(86) PCT No.: PCT/AU2023/051152

§ 371 Date: May 13, 2025

(30) Foreign Application Priority Data
Nov. 14, 2022 (AU) 2022903422

(51) Int. Cl. A01G 9/02; A01G 9/033

(52) U.S. Cl. CPC A01G 9/027; A01G 9/033

(57) ABSTRACT

A tray (10) for use in a green roof system has a floor (12) and four sides (14) and is moulded from a plastics material. At the centre of, and towards the base of each side wall, there is a circular hole/orifice (20) for use in connecting the interior of one tray with an adjacent tray. The trays may be connected together using male (24) and female (30) connectors and used particularly on roofs for temporary (or more permanent water storage and as a planting box for a green roof. The trays (10) may be linked together by fluid flow connectors (50) which include a short length of piping/tubing linking the holes of adjacent trays for fluid flow between trays. Connectors which block passage of fluid between two adjacent trays are also provided. A further connector which has a partial passage including a dam wall is also provided. The trays (10) can be connected to form a reservoir on the roof of a building with the connectors being used to control the flow of water e.g blocking the passage of water on downhill slopes.

### CROSS-REFERENCE TO RELATED APPLICATIONS

The present application claims priority from Australian Provisional Patent Application No 2022903422 filed on 14 Nov. 2022, the contents of which are incorporated herein by reference in their entirety.

### TECHNICAL FIELD

This invention relates to a planter or roof tray for use in forming a “green roof” on top a building, typically, but not exclusively, on the roof of a high rise building in a urban environment.

### BACKGROUND

Cities tend to be much warmer than surrounding rural land due to the build up of heat in the buildings that make up the city. It is known and highly desirable to “green” building roofs, particularly high rise buildings, by covering them in growing plants/gardens to provide amenities for occupants of the buildings, to reduce reflected heat, and to improve the environment generally by absorbing rainwater, carbon dioxide etc.

Existing green roofs may be grown in situ in planting medium supported on various layers including waterproofing, a root guard layer drainage layer etc.

Such systems do not work well with all type of roofs, often cause water leakage and other problems, and it is known to provide planting trays which sit on top of the top of the building roofs.

However, there are also number of problems with planting trays, and in particular, the sealing between the pipes linking the trays together is not always reliable and can lead to water leaking onto the roof. Setting up the green roof is fiddly. The step of connecting the trays in fluid connection with each other is usually awkward. It is also difficult to remove one tray and replace it with another replacement tray.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY

Thus according to the invention, there is provided a modular green roof system comprising a base tray having a base, side walls and connecting means for connecting the trays in a side by side array, the side walls defining an aperture to allow fluid to flow from or into the tray wherein the side walls of the tray are connectable together by (male and female) connecting formations defined on the side walls of the tray at the top of the tray in which arrangement the apertures of the connected trays are opposed and separated by a gap and further including a further fluid flow connector which can be slid between the apertures and which defines a tubular portion connecting the apertures together allowing the passage of fluid from one tray to the connected tray.

Advantageously, using the system, the trays can be initially connected together very quickly in any array using the connectors at the top of the trays, and then subsequently the connectors can be inserted between the trays to allow the flow of fluid from one tray to another.

Typically, the tray is generally square in plan view, and has four side walls and the aperture is located in the centre of each side wall towards the base of the tray. It is preferred that the side walls taper outwardly from the base to the top. This makes the trays easier to manufacture and to stack for transport.

In a preferred feature, there are a series of internal walls extending upwards from the base of the tray for supporting an inner tray, sheet of geotextile or the like.

Typically the internal walls may be in the form of formations and are cruciform in plan view. They may taper from the base to their top.

In a preferred embodiment, a small horizontal step is defined in the side wall, above the aperture but below the rim, typically at about the height of the top of the internal walls, in which a series of drainage holes are defined.

In a preferred embodiment, the tray includes a projecting rim and the male and female connecting formations are defined on the rim.

Having the male and female connectors on the rim, makes connection quicker and easier than joining the trays with pipes and the projecting rim ensures there is a sufficient gap between the trays to receive the fluid flow connectors.

The system may further include an inner tray, locatable in the base tray supported by the formations, the tray defining an array of cavities depending down from an upper surface of the inner tray, which surface defines a plurality of apertures.

Preferably, the walls of the tray define a recess in which the aperture is defined, the recess having opposed side walls which extend vertically upwards and wherein at the top of the recess a tab from the rim into the recess.

Preferably, the fluid flow connector defines two opposed walls connected by the tubular portion, and a top portion connecting the two, and the top portion defines one or more grooves for receiving the tabs defined in the rim.

It is preferred that the fluid flow connector defines an aperture size which can receive a standard size drainage pipe. This makes it simpler to connect the system to roof top water drainage systems and the like.

The invention also encompasses the individual base tray and the individual fluid flow connector, and in particular in a tray for use in a green roof system having a base, side walls and connecting means for connecting the trays in a side by side array, the side walls defining an aperture to allow fluid to flow from or into the tray wherein the side walls of the tray are connectable together by (male and female) connecting formations defined on the side walls of the tray in which arrangement the apertures of the connected trays are opposed and separated by a gap and the gap is configured to receive a connector which can be slid between the apertures and which defines a tubular portion connecting the apertures together allowing the passage of fluid from one tray to the connected tray.

Advantageously, the green roof system is low maintenance as much of the water required to maintain the green roof is provided by rain. The fluid flow connectors allow excess water which falls on one part of the roof to flow and water other areas. That makes the system particularly suitable for us on a roof having solar panels as the panels cover the roof to an extent. The green roof may advantageously assist in keeping the solar panels cooler than they would be if mounted on an exposed concrete roof.

The invention also encompasses a green roof system comprising a plurality of trays according to the first aspect, interconnected together and including fluid flow connectors allowing the flow of fluid between trays, wherein the trays defines a series of walls extending upwards from the base of the tray supporting an inner tray above the base of the tray and defining a reservoir below the tray, further including control unit operatively connected to an adjustable valve, such as a rotary valve or the like, for controlling and varying the rate of flow of water out of the green roof to the roof drainage system/down pipes, the system including one or more sensor indicating the water level in the one or more of tanks which is provided to the control unit, the control unit adjusting the flow of water from the system based on the indicated water level.

Preferably, the control unit is supplied with weather information such as expected rainfall and duration of rainfall and is arranged to adjust the valve also based on the weather information.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Specific embodiments of the invention will now be described by way of example only and with reference to the accompanying drawings in which:—FIG. 1 shows an assembly including a roof tray and inner tray and additional components;

FIG. 2 shows a top isometric view of a base roof tray;

FIG. 2a is an enlarged view of a corner of the tray of FIG. 2;

FIG. 3 shows a bottom isometric view of the base roof tray of FIG. 2;

FIG. 4 shows a side view of the base roof tray of FIG. 2;

FIG. 5 shows a top plan view of the base roof tray of FIG. 2;

FIG. 5a shows an enlarged perspective view illustrating male and female connectors disposed either side of an aperture defined in the side of the tray;

FIG. 5b shows and enlargement of part of the top plan view shown in FIG. 5b illustrating the connectors in more detail.

FIG. 6 shows an isometric view of an inner tray for the base roof tray

FIG. 7 shows a side view of the inner tray of FIG. 3;

FIG. 8 shows a top isometric view of the base roof tray of FIG. 2 including an inner tray;

FIG. 9 shows a top isometric view of the base roof tray of FIG. 2 including an inner tray and erosion guards;

FIG. 10 shows a front perspective view of an open fluid flow connector joiner;

FIG. 11 shows an end view of the fluid flow connector of FIG. 10;

FIG. 12 shows a top view of the fluid flow connector of FIG. 10;

FIG. 13 shows a front view of the fluid flow connector of FIG. 10;

FIG. 14 shows a front perspective view of a closed fluid flow connector;

FIG. 16 is a perspective view showing two trays connected together along one side;

FIG. 17 is a top perspective view of the two trays shown in FIG. 15;

FIG. 17a is an enlarged view of part of FIG. 16 illustrating a gap between the two trays;

FIG. 18 illustrates the use of geotextile to form wicks; and

FIG. 19 is a schematic view illustrating the use of the tray as part of a “blue roof”.

### DESCRIPTION OF EMBODIMENTS

Referring to the drawings, FIG. 1 shows an assembly 100 including a roof tray 10 with a number of additional components, described in more detail below.

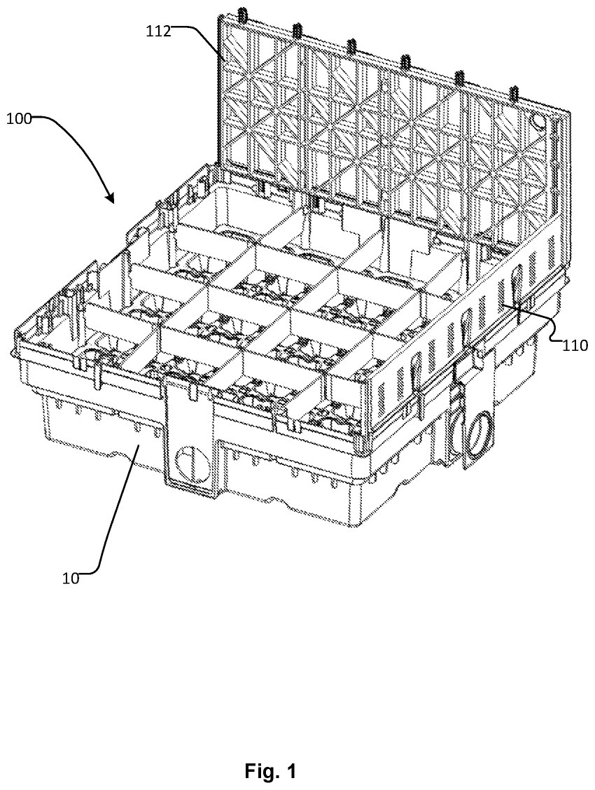

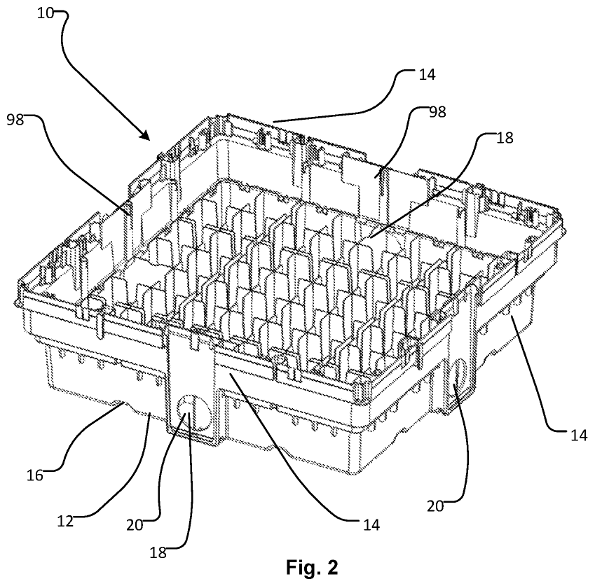

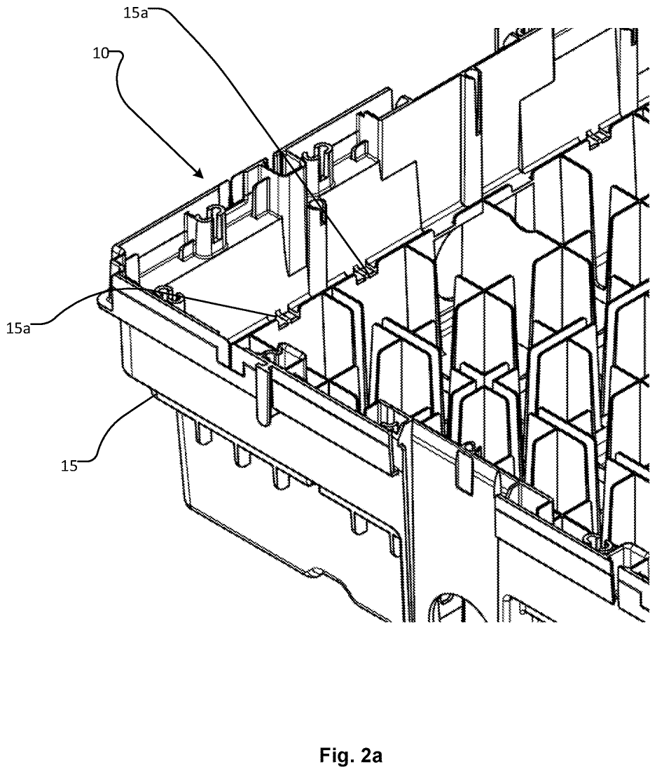

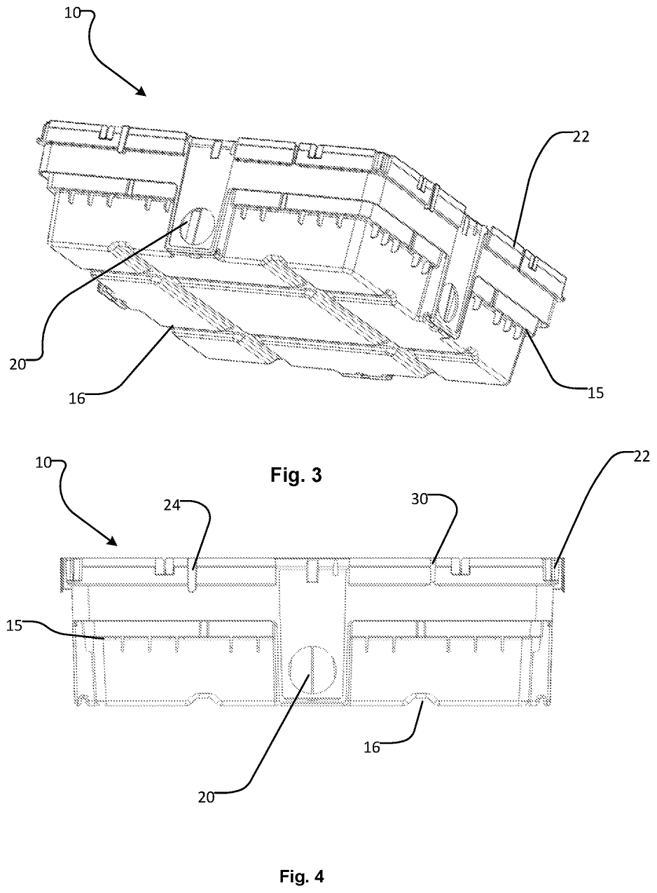

FIGS. 2 to 5b show the roof tray 10 in more detail. The roof tray has a base 12, four identical side walls 14 and an open top. As is best seen in FIGS. 3 and 4, a series of intersecting channels 16 in the shape of a hashtag are defined in the underside of the tray. This is to allow the passage of water under the tray and inhibits pooling of water under or adjacent the tray.

The tray 10 is generally square in plan view, and the sides 12 are about 500 mm long and 150 mm high. The sides taper outwards slightly from the base to the open top. This allows the trays to nest when stacked one on top of another, and also ensures that when the tops of the sides are connected a gap is defined between the sides of adjacent trays at the base. The tray is injection moulded in a suitable plastics material, typically recycled or part recycled plastics.

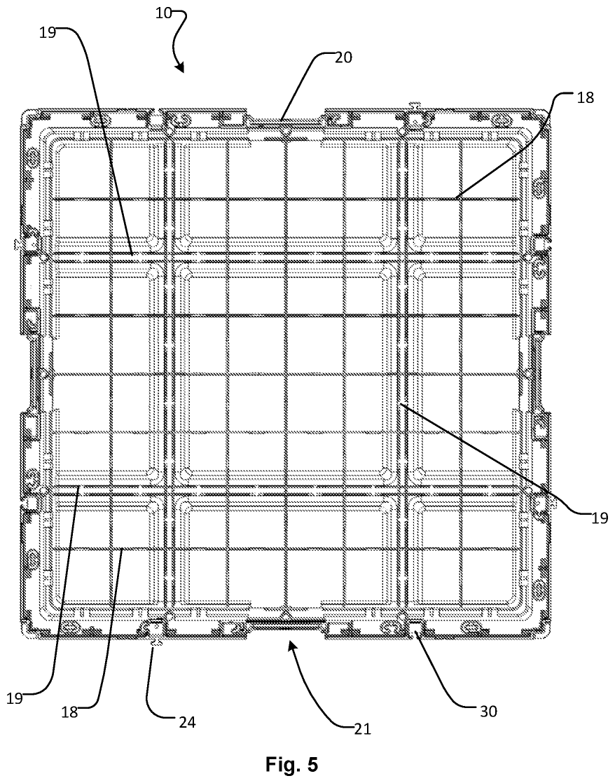

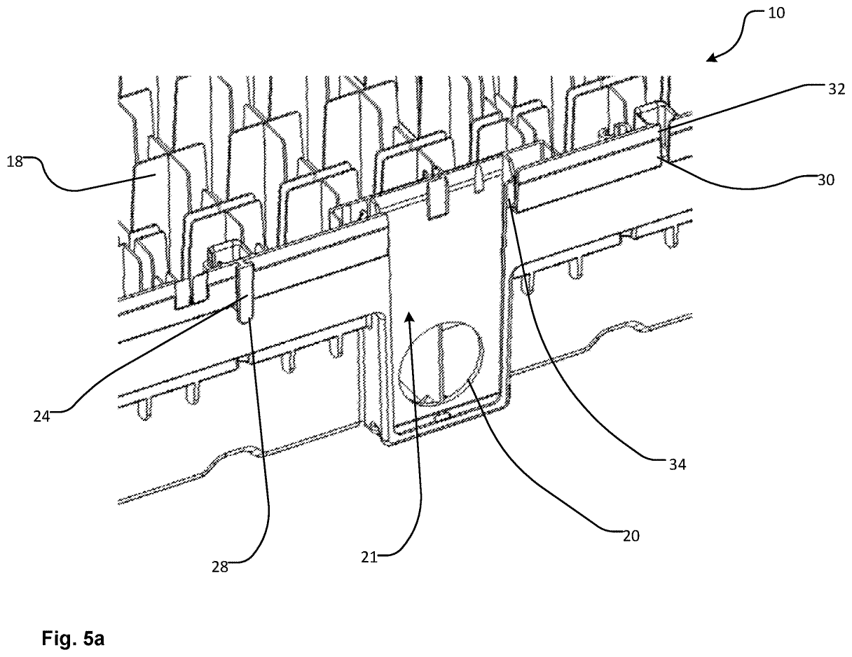

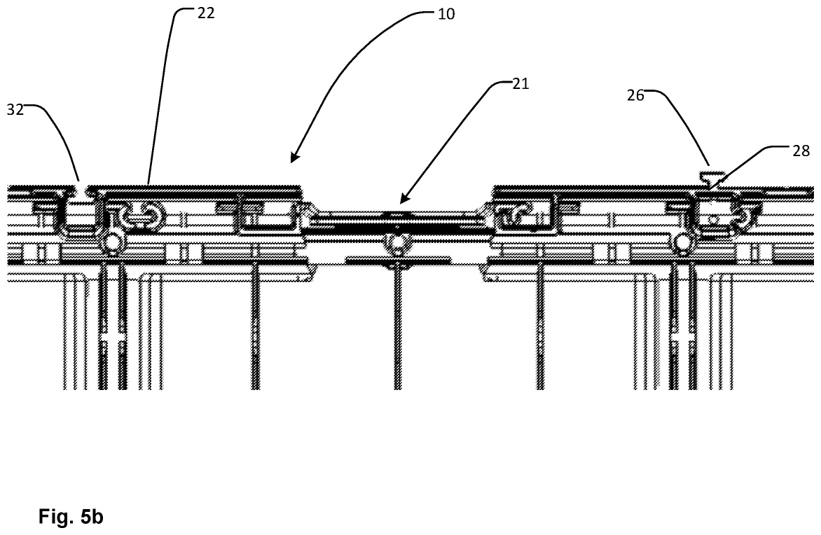

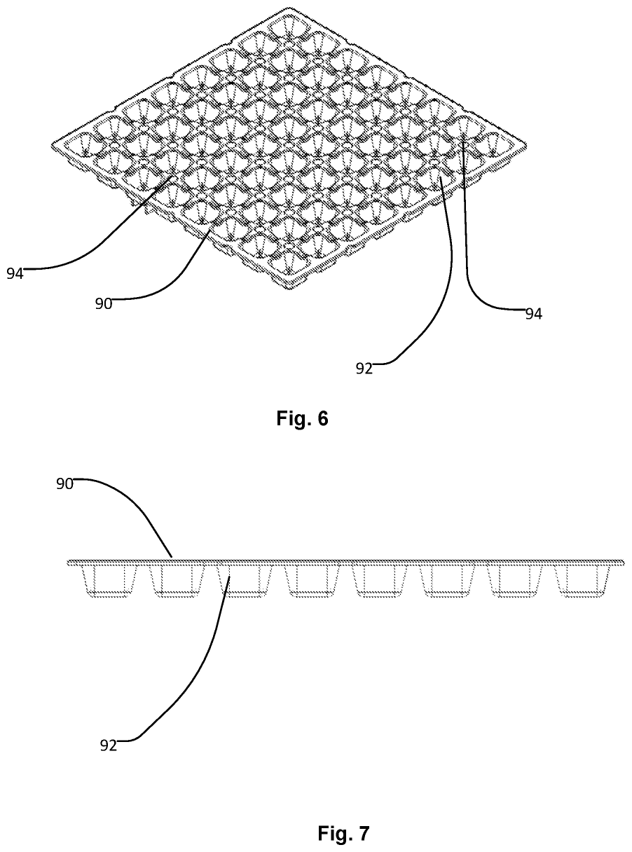

In the centre of each side wall 14, towards the base 12 of the tray, there is a circular aperture 20. Inside the tray there is an array of tapering cruciform formations/internal walls 18 which extend upwards from the base to approximately half way up the height of the sides of the base. The cruciform formations 18 taper from their base to their top to allow them to be removed from the mould more easily. The tops of the formations/walls provide a support for a secondary tray 50 (refer to FIGS. 6 and 7), sheet of geotextile or the like, or other support for a growing medium and/or plants. As is best seen in FIG. 5, there are gaps/slots 19 between the walls 18, which extend across the tray across both axes, the use of which is described below. As can be seen from FIG. 2, one of the walls/formations 18 extends as far as and bisects the aperture 20. This supports the edges of a geotextile sheet (not shown) located inside the tray and prevents the geotextile or growing medium from drooping and blocking the aperture.

As is best seen in FIG. 4, the side walls 14 taper outwards slightly from the base to the open top. About midway up the walls there is a small step 15 in which a series of drainage holes 15a are defined, as is best seen in FIG. 2a. At the top there is a projecting rim 22 which extends outwards beyond the plane of the side walls, except above each of the apertures 20 where there is a gap in the rim. Two or more trays may be connected together by using male and female connecting formations/connectors defined on the rim 22, as is best seen in FIGS. 5 to 5b. On the left side of the side wall relative to the aperture 20 there is a projecting male connector 24. As is best seen in FIGS. 5a and 5b, the male connector 24 has a generally T-shaped constant cross-section in a vertical axis defining a narrow stem 26 and a wider cross piece or end flange 28. A corresponding female socket 30 is configured to receive the male locking element on the right side of the aperture, so that the trays 10 can be engaged together side wall to side wall in a sliding arrangement. Referring to FIG. 5b, the female socket 30 defines a narrow slot 32 in the rim 22 which receives the stem 26 behind which there is a space to receive the flange 28.

As is best seen in FIGS. 5 to 5b, the tray is slightly recessed where the aperture 20 is defined. The recess 21 has opposed side walls which extend vertically upwards. At the top of the recess a projection or tongue 34 extends from the rim into the recess, which in use inserts into a corresponding groove on a connector or edge closer, as is described in more detail below. FIG. 5a shows one tongue, 34a, the opposed tongue 34b is hidden in FIG. 5a but shown in FIG. 2.

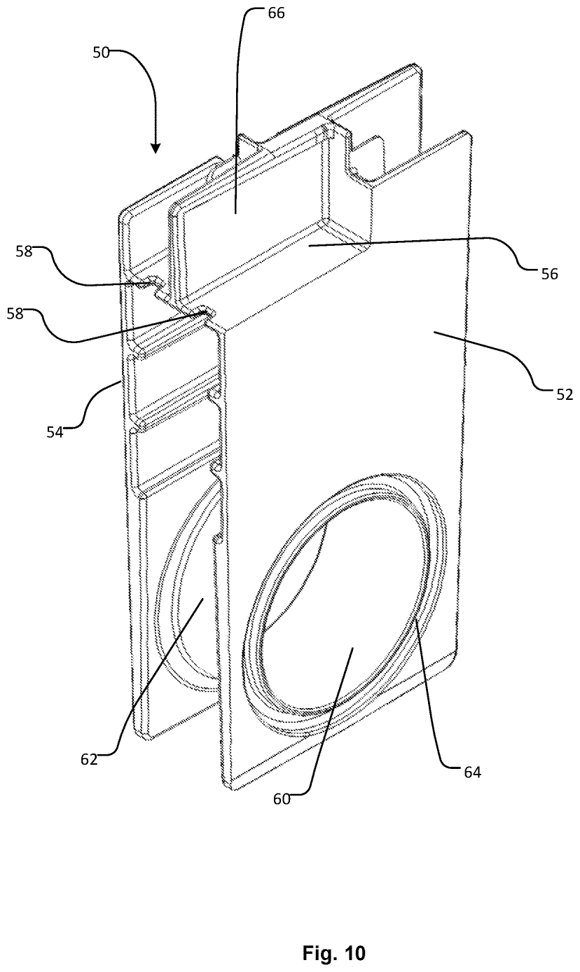

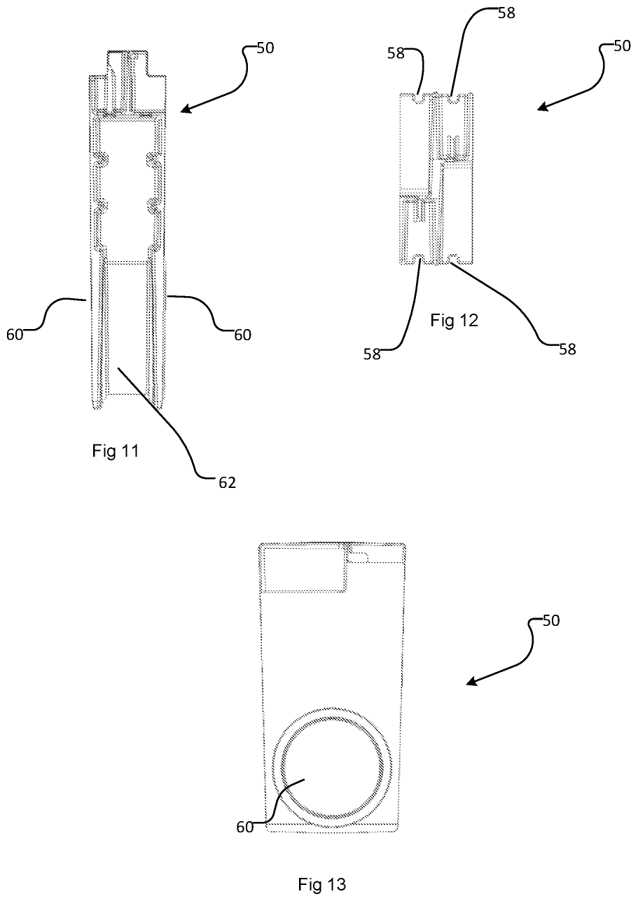

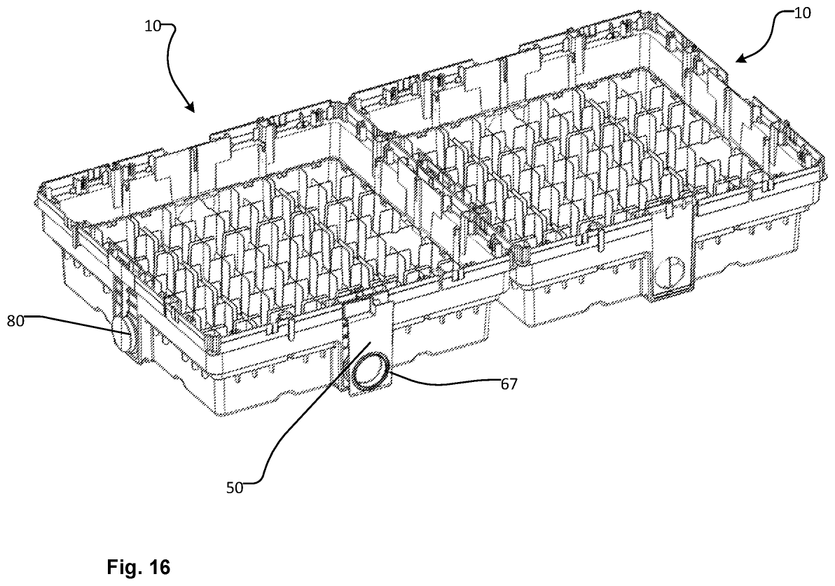

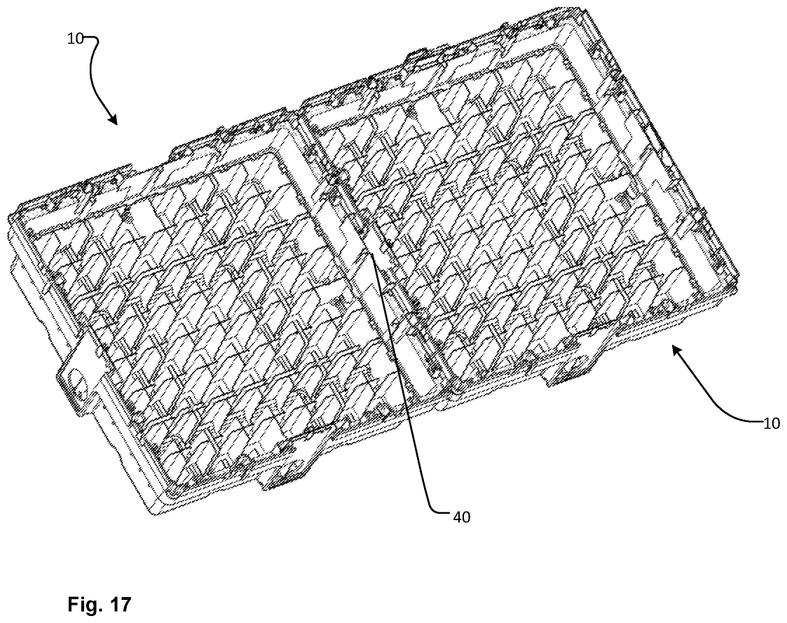

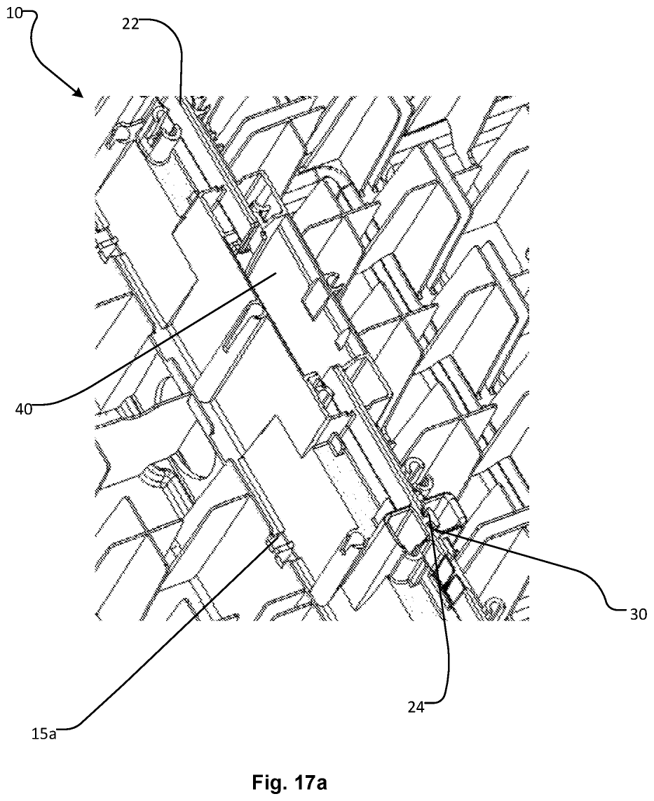

In normal use, multiple trays are connected side by side in a continuous array extending in both x and y directions in a generally horizontal plane. FIGS. 16 and 17 show just two trays 10 connected along opposed sides. As is best seen in FIG. 17a, at the top of each tray where the rims 22 abut the male connector 24 on one tray side fits into the corresponding female connector 30 of the adjacent tray. Also as best seen in FIGS. 17 and 17a when this connection is made, there is a gap 40 between the side walls above the outlets. It is to be noted that the connection between the male and female connectors can be somewhat loose and allow some play and relative movement between trays. Being located at the top of the tray, well above the apertures 20, and because they are not required to provide fluid flow, the array of trays can be assembled very quickly as they slot together easily. The gap 40 receives a fluid flow connector 50 (described below) which slots into the gap 40. The selection of which connector determines whether water can flow between the adjacent trays or not. In most cases, a though fluid flow connector will be used such as shown in FIGS. 10 to 13.

FIGS. 10 to 13 show an open fluid flow connector 50 for linking the outlets of the trays together. The fluid flow connector defines two opposed walls 52, 54 which are connected at the top by a horizontal top plate or roof portion 56. Both side edges of the top 56 define two nicks or grooves 58 (only two of which are visible in FIG. 10, which are best shown in FIG. 12) which, as will be explained in more detail below, cooperate with the tongues 34 defined in the rims 22 of the trays, in a tongue and groove type connection to locate and retain the fluid flow connectors in place. Opposed circular apertures 60 are defined near the base of each wall 52, 54 connected by a short annular through tube 62. The tube is sized to receive a standard size drainage pipe for ease of connection of the system to building drainage systems, down pipes and the like. Extending around the perimeter of each aperture 60 there is a recess or channel 64 having a semi-circular cross-section which in use receives an O-ring seal 67 (not shown in FIGS. 10 to 13, but shown in FIG. 16). A vertical tab 66 extends up from the top portion 56 which can be gripped to manipulate the connector and push it into the gap 40. In an alternative embodiment, not illustrated, the tab 66 may define a hole to assist in pulling the fluid flow connector out the gap when it becomes necessary to remove a tray from the array. In use, the connector 50 is inserted into the gap 40 between two adjacent trays and when pushed to the base of the gap, the tube 60 aligns with the apertures in the adjacent trays allowing the passage of water from one tray to another. The O-rings 67 are located in the recesses 64 on each side of the connector to enhance the functionality of the system and ensure an optimum seal, however it would be possible to have a reasonable seal, without using an O-ring. Advantageously, the O-rings are compressed in the gap 40 and tend to bias the trays apart which removes much of the play provided by the male and female connectors. When inserted into the gap 40, the tabs 32 engage with the grooves 58 in a tongue and groove type locking arrangement.

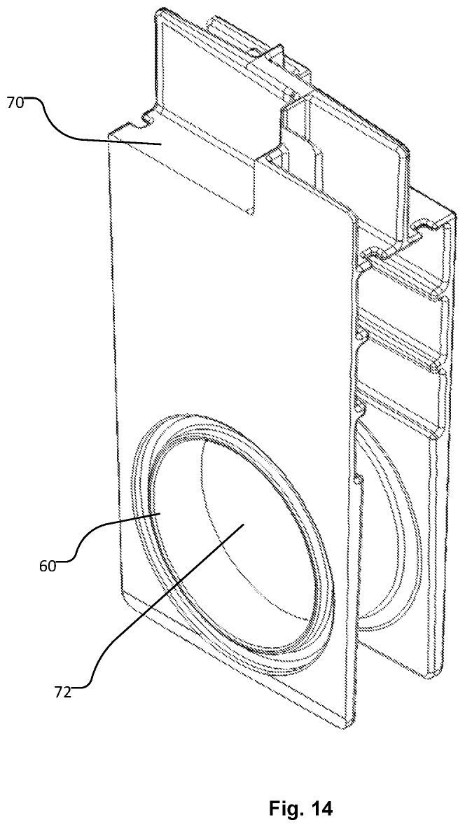

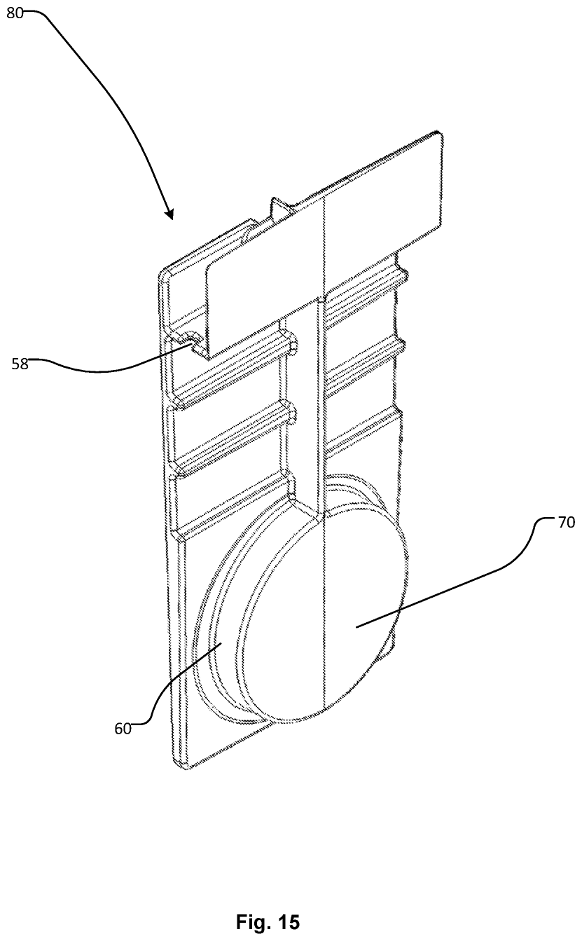

FIG. 14 shows a closed connector 70 which is substantially identical to the open fluid flow connector and the same parts have the same reference numerals The only difference between the open fluid flow connector 40 and the closed connector 70 is that the tube 60 between the two walls is closed by a seal/plate 72 to prevent the passage of water through the tube.

FIG. 15 shows an edge closer 80 which is configured to close the apertures of the trays which face the exterior of the array. The edge closer is essentially one half of a closed connector and the same features carry the same reference numbers. The edge closer locates in the recess 21 of the array and closes the aperture 20 with the end seal 72 and an O-ring (not shown). The edge closer 80 is locked into the recess 21 by the tongue and groove mechanism provided by the tabs 34 in the rim 22 engaging in the grooves 58 on either side of the edge closer.

FIGS. 6 and 7 show a secondary or inner tray 90 which in use may be placed inside the tray 10 supported on the internal wall formations 16. The tray is similar in shape to a chocolate box tray defining an 8 by 8 array of generally square tapering cavities 92 which depend down from the top of the tray. In the top of the tray a series of circular apertures 94 are defined.

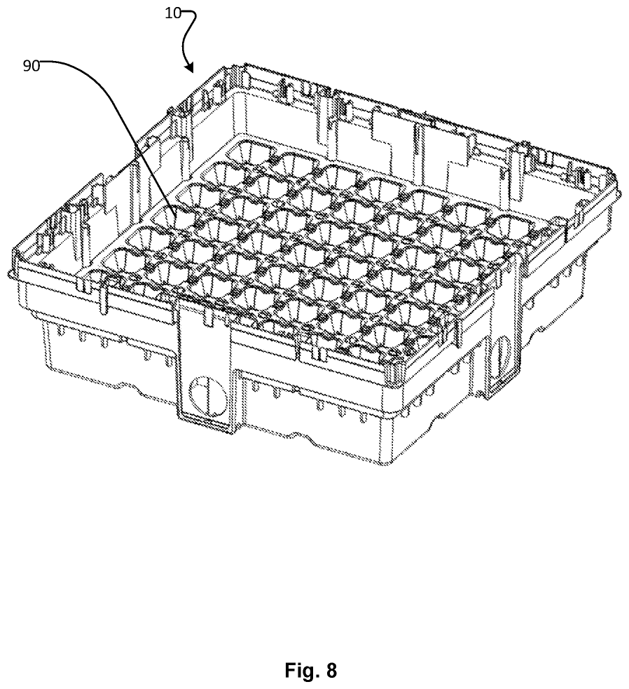

In use, the secondary tray is placed in the main tray as shown in FIG. 8 and a layer of geotextile is placed directly over it before the growing medium and optionally plants (not shown) are placed over the growing medium. Any rain falling into the tray will tend to pool in the cavities and when the cavities become full, the water level will rise to the level of the top of the tray and flow through the apertures 94 into the main tray. The apertures may also be used to draw any water in the main tray up to the growing medium if wicks (not shown) are placed in apertures extending from the bottom of the main tray up to the growing medium in the upper part of the tray.

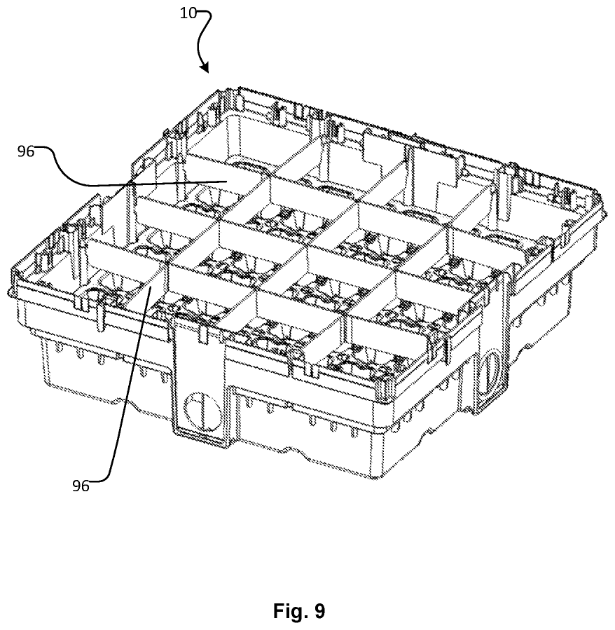

FIG. 9 illustrates the use of optional erosion guards 96 which are intersecting sheets of plastic. The ends of the sheets fit into recesses 98 formed on the inside walls of the tray 10 (best seen in FIG. 2). The erosion guards help keep the growing medium evenly dispersed in the tray, particularly on sloping roofs.

FIG. 1 shows two additional accessories which can be clipped onto the tray to increase the height/depth of the trays in the form of a side extender 110 and a side extension panel 112.

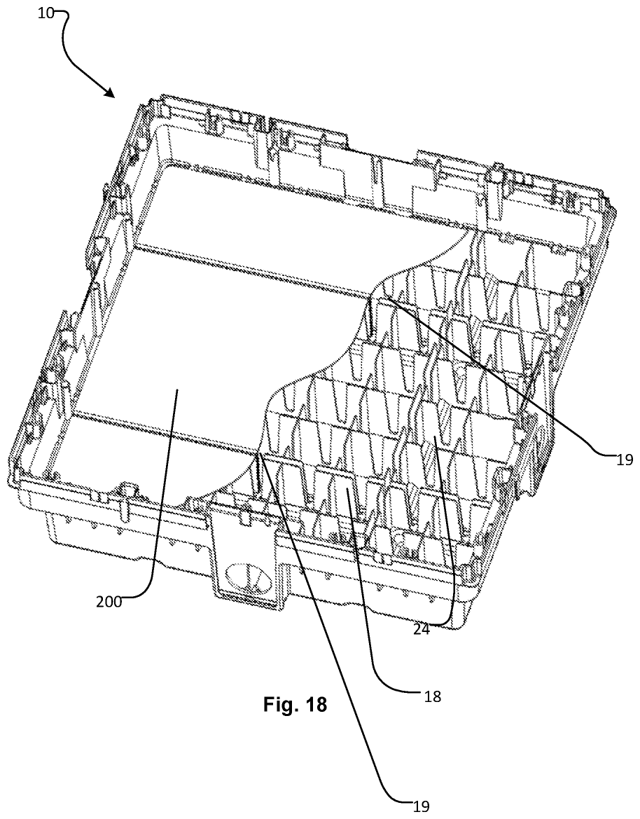

In use, a plurality of trays 10 are assembled in an array and where the side walls face each other either closed connectors 70 or open connectors 50 are used to connect or close off the apertures 20. Edge closers 80 are used to cover the apertures 20 around the edge of the array. Some edge apertures may instead be connected to stormwater, downpipes, or other pipes for the transfer of excess water, e.g. during heavy rains or storms. The formations on the trays 10 may be covered with sheets of geotextile 200 or the like or the inner trays 90, which are subsequently covered with geotextile. As shown in FIG. 18, the geotextile 200 covering the formations 18 can be pushed down into the gaps/slots 19 between two adjacent wall formations. In this case the geotextile will act as a wick and draw moisture upwards. As an alternative, (not shown), instead of pushing the geotextile into the gaps, separate strips of geotextile, typically about 500 mm by 300 mm can first be pushed into the slots to form a “T” shape before the geotextile is placed over the “T” shaped wicks. The trays can then be filled with growing medium and plants. Side extenders 110 and/or side extension panels 112 may be used where greater depth of growing medium is needed or where protection for the growing plants from wind or the like, is required.

The provision of connectors which allow or block the passage of water from one tray to another allows for the control of the flow water in an array of roof trays. Typically edge closers will be used around the edge of the array, to keep rain and storm water within the array, although some of the apertures around the outside of the array may be connected to stormwater down pipes, drain pipes or the like and the connectors are sized to receive standard size drainage pipes to facilitate this. For example, where roofs are sloping, closed connectors may be used on the downslope sides to trays to encourage water to travel across rather than down the slope. It is also envisaged that a further connector which is closed part way up the tube 60 which is part closed may be provided for water control. The modular nature of the system allows different configurations to be assembled from the basic components. The trays may be assembled together prefilled with growing medium and plants. The connection system is reliable in terms of being water tight but also allows for the removal of individual trays and swapping those trays for new trays, where for example the plants in one tray are dead or diseased, of the tray is damaged.

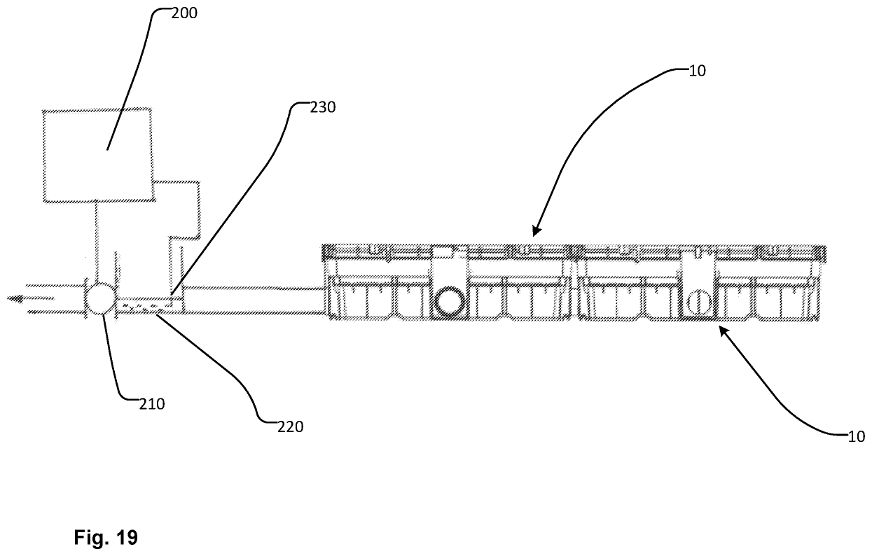

Referring to FIG. 19, the system can be used for a “blue roof” system where water levels can be controlled, through the use of one or more control valves. During heavy rainfall water is retained in the trays (acting as a detention tank), and is then slowly released to the drainage system by opening the control valves. This helps prevent overload of drainage networks during heavy rain. The perimeter drainage holes 15a, see FIG. 2a, also allow excess water to drain from the tanks during very heavy rainfall events, when the system is being used as a “blue roof” and the drainage system is not able to handle the volume of flow of water.

In particular, FIG. 19 shows a control unit 200 which is connected to and controls a rotary valve 210. As is well known, a rotary valve is controllable and can be opened different amounts to regulate fluid flow. The valve or valves control the flow of water out of the green roof to the roof drainage system/down pipes. Other suitable valves could be used. A tank 120 is provided next to the valve which has a sensor indicates the water level in the tanks and feeds that information to the control 200. Alternatively, or in addition, sensors in one or more of the roof trays can measure the water level in the roof trays. The valve 110 may initially be closed, or part closed. When it rains, firstly the growing medium of the plants receives the water and excess water collects in the tray 90 below the plants. After the tray fills, excess water then collects in the main tray. The valve will open and close to regulate the outflow of water, noting that it is desirable to allow excess water to exit the tanks within a certain time period, say 24 hours, for example. The control unit is also linked to weather information, so it will be forewarned of the amount and duration of rain that is expected. So if rain is expected in an hours' time, and there is still water in the tank 120, the valve may be fully opened to release all the water contained in the tank ready for the next rain event.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A modular green roof system comprising a tray having a base, side walls and connecting means for connecting the tray in a side by side array with a second, substantially identical, tray, the side walls of the tray defining an aperture to allow fluid to flow from or into the tray wherein the side walls of the tray are connectable together by male and female connectors defined on top of the side walls of the tray in which arrangement the apertures of the connected trays are opposed and separated by a gap and the trays are, at least loosely, linked together; and
further including a fluid flow connector configured to be slid between the apertures and which defines a tubular portion for connecting the apertures together allowing the passage of fluid from the one tray to the second, connected, tray.

2. A system as claimed in claim 1 wherein the tray is generally square in plan view and has four side walls which taper outwardly from the base to the top and wherein the aperture is located in the centre of each side wall towards the base of the tray.

3. A system as claimed in claim 1 wherein the tray includes a projecting rim and the male and female connecting formations are defined on the rim, the male connectors being generally T-shaped including a stem and a cross-piece, and the female connectors defining a slot for receiving the stem which is narrower than the crosspiece and a space behind the slot for receiving the cross-piece.

4. A system as claimed in claim 1 wherein the connection between the male and female connectors is relatively loose and allows some movement between the trays.

5. A system as claimed in claim 1 including a series of internal walls extending upwards from the base of the tray for supporting an inner tray or sheet of geotextile.

6. A system as claimed in claim 5 wherein the internal walls are in the form of cruciform formations in plan view and wherein the cruciform formations taper from the base to their top.

7. A system as claimed in claim 6 wherein a small horizontal step is defined in the sidewall, above the aperture but below the rim, at about the height of a top of the internal walls, in which step a series of drainage holes are defined.

8. A system as claimed in claim 6 further including an inner tray, locatable in the base tray supported by the cruciform formations, the inner tray defining an array of cavities depending down from an upper surface of the inner tray, which surface defines a plurality of apertures.

9. A system as claimed in claim 1 wherein the side walls of the tray define a recess in which the aperture is defined, the recess having opposed side walls which extend vertically upwards and wherein at the top of each side wall of the recess, a tab projects from the rim of the tray into the recess.

10. A system as claimed in claim 9 wherein the fluid flow connector defines two opposed walls connected by the tubular portion, and a top portion connecting the two and the top portion defines one or more grooves for receiving the tabs defined on the rim.

11. A system as claimed in claim 1 wherein the fluid flow connector defines an aperture size which can receive a standard size drainage pipe.

12. A tray for use in a green roof system having a base, side walls and connecting means for connecting the trays in a side by side array with a second, substantially identical tray, the side walls defining an aperture to allow fluid to flow from or into the tray, wherein the side walls of the tray are connectable together by male and female connectors defined on the side walls of the tray by means of which connectors, the trays may be, at least loosely, linked together, in which arrangement the apertures of the connected trays are opposed and separated by a gap and wherein the gap is configured to receive a fluid flow connector which can be slid between the apertures and which defines a tubular portion connecting the apertures together allowing the passage of fluid from one tray to the connected tray.

13. A green roof system comprising a plurality of trays as claimed in claim 12 interconnected together and including fluid flow connectors allowing the flow of fluid between trays, wherein the trays defines a series of walls extending upwards from the base of the tray supporting an inner tray above the base of the tray and defining a reservoir below the tray, further including control unit operatively connected to an adjustable valve, such as a rotary valve or the like, for controlling and varying the rate of flow of water out of the green roof to the roof drainage system/down pipes, the system including one or more sensor indicating the water level in the one or more of trays which is provided to the control unit, the control unit adjusting the flow of water from the system based on the indicated water level.

14. A green roof system as claimed in claim 13 wherein the control unit is supplied with weather information such as expected rainfall and duration of rainfall and is arranged to adjust the valve also based on the weather information.

15. A green roof system as claimed in claim 13 including growing medium and plants supported by the inner tray.
